(19) United States
(12) Patent Application Publication
(10) Pub. No.: US 2015/0290936 A1
(43) Pub. Date: Oct. 15, 2015

(54) LIQUID EJECTION HEAD

(71) Applicants: KABUSHIKI KAISHA TOSHIBA, Tokyo (JP); TOSHIBA TEC KABUSHIKI KAISHA, Tokyo (JP)

(72) Inventor: Isao Suzuki, Mishima (JP)

(21) Appl. No.: 14/681,288

(22) Filed: Apr. 8, 2015

(30) Foreign Application Priority Data
Apr. 9, 2014 (JP) 2014-080303

(51) Int. Cl. B41J 2/14

(52) U.S. Cl. CPC B41J 2/14201

(57) ABSTRACT

In accordance with an embodiment, a liquid ejection head comprises a pressure generation chamber in which liquid is filled; a plate configured to connect with the pressure generation chamber and include a plurality of liquid ejection sections of which the axes are directed to the center direction of an impact area of the liquid; and a driver configured to enable a pressure in the pressure generation chamber to fluctuate.

### CROSS-REFERENCE TO RELATED APPLICATION

This application is based upon and claims the benefit of priority from Japanese Patent Application No. 2014-080303, filed Apr. 9, 2014, the entire contents of which are incorporated herein by reference.

### FIELD

Embodiments described herein relate generally to a liquid ejection head which ejects liquid from a nozzle.

### BACKGROUND

There is a liquid jet head which consists of a plurality of nozzles in one pressure generation chamber to increase the ejection amount of liquid from the pressure generation chamber to enable the liquid to impact on an ejection target object efficiently. However, in a case of ejecting liquid from the plurality of nozzles arranged in one pressure generation chamber, there is a possibility that the impact dots of liquid disperse and expand, and as a result, a high concentration printing or high-speed printing cannot be obtained.

### BRIEF DESCRIPTIONS OF THE DRAWING

FIG. 1 is a perspective view schematically illustrating a dispersed inkjet head according to an embodiment;

FIG. 2A is a schematic illustration diagram illustrating a head portion of the inkjet head according to the embodiment observed from a lateral side;

FIG. 2B is a schematic illustration diagram illustrating a head portion of the inkjet head according to the embodiment observed from a plane side;

FIG. 3 is a schematic illustration diagram illustrating a direction of axis and a dot area of nozzles according to the embodiment;

FIG. 4 is a schematic illustration diagram illustrating a direction of axis and a dot area of nozzles according to a comparative embodiment; and

FIG. 5 is a schematic illustration diagram illustrating a direction of axis and a dot area of nozzles according to a modification of the embodiment.

### DETAILED DESCRIPTION

In accordance with an embodiment, a liquid ejection head comprises a pressure generation chamber in which liquid is filled; a plate configured to connect with the pressure generation chamber and include a plurality of liquid ejection sections of which the axes are directed to the center direction of an impact area of the liquid; and a driver configured to enable a pressure in the pressure generation chamber to fluctuate.

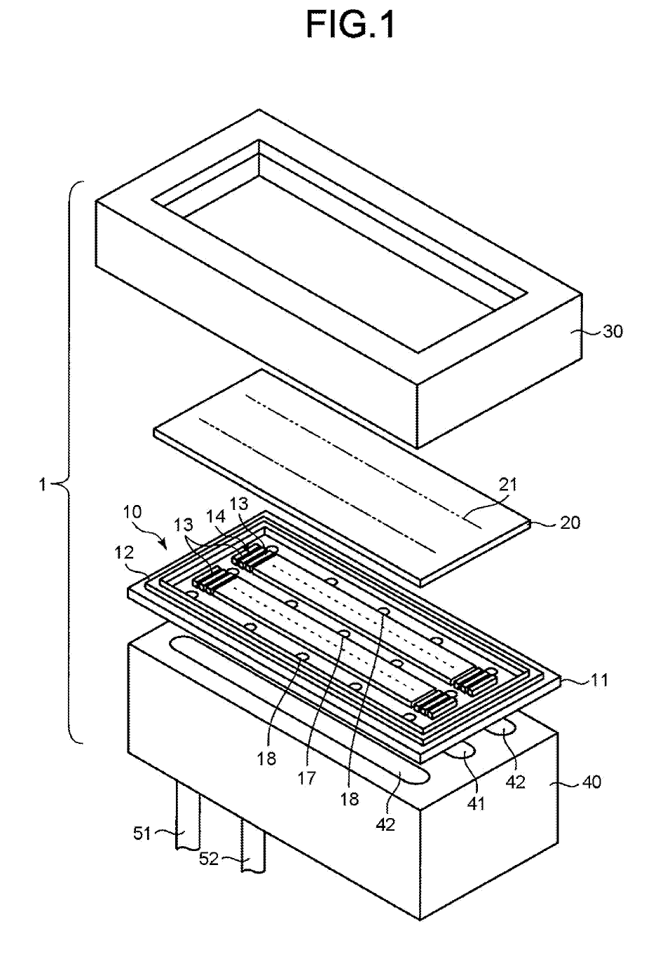

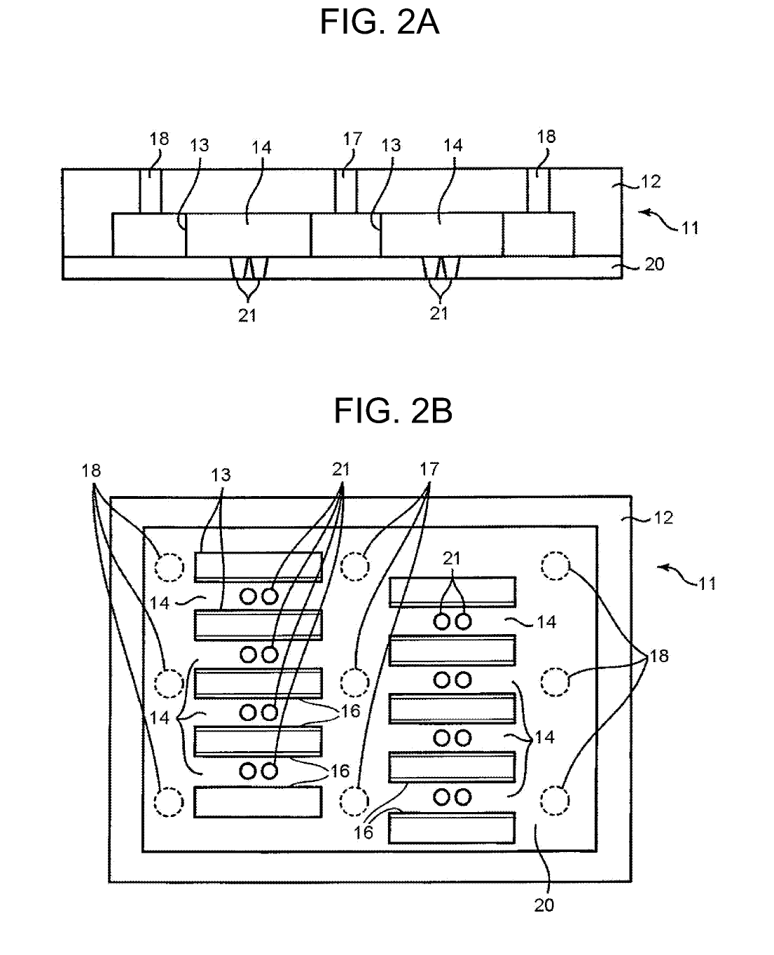

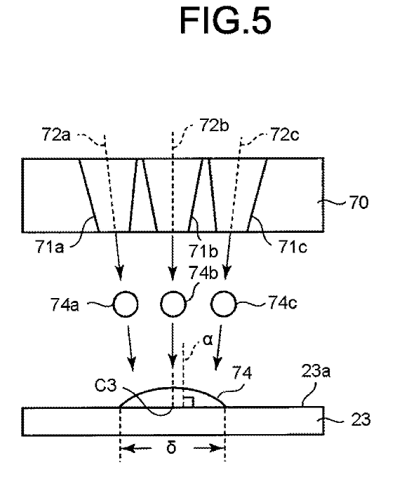

Hereinafter, the present embodiment is described with reference to FIG. 1˜FIG. 5. FIG. 1 illustrates an inkjet head 1 serving as a liquid ejection head according to the embodiment. The inkjet head 1 comprises a head portion 10, a mask plate 30 and a holder 40. The head portion 10 is provided with an ink pressure chamber structure body 11 and a nozzle plate 20 serving as the plate.

The ink pressure chamber structure body 11 is, for example, formed with ceramic such as alumina, or glass. A plurality of piezoelectric member partition walls 13 serving as driving sections (driver) is formed in the interior side surrounded by a frame 12 of the ink pressure chamber structure body 11. The plurality of piezoelectric member partition walls 13 is arranged in two rows in the interior side surrounded by a frame 12 of the ink pressure chamber structure body 11. The piezoelectric member partition wall 13 is made from a piezoelectric material having a high electrostriction constant such as the PZT (lead zirconate titanate (Pb (Zr, Ti)O₃) and the like.

The arrangement of the plurality of piezoelectric member partition walls 13 formed in the ink pressure chamber structure body 11 is not limited to two rows, and may be one row or more than three rows.

The nozzle plate 20 is, for example, formed by resin such as polyimide, or metal having heat-resistance such as a nickel alloy and stainless steel. In the nozzle plate 20, a plurality of nozzles 21 serving as liquid ejection sections which pierces the nozzle plate 20 in the depth direction thereof is formed. The nozzle plate 20 is bonded to the frame 12 and the piezoelectric member partition walls 13.

A space surrounded by the frame 12, the piezoelectric member partition wall 13 and the nozzle plate 20 constitutes an ink pressure chamber 14 serving as the pressure generation chamber. The nozzles 21 formed in the nozzle plate 20 are connected to the ink pressure chambers 14. In the head portion 10, two nozzles 21 (a nozzle 21a and a nozzle 21b) are arranged for each ink pressure chamber 14. By arranging two nozzles 21 for each ink pressure chamber 14, the inkjet head 1 ejects a desired amount of ink serving as the liquid to an image receiving medium efficiently. The ink is made of, for example, an organic solvent, an aqueous solution or the like

The ink pressure chamber structure body 11 includes an ink supply port 17 and an ink discharge port 18. The ink supply port 17 supplies ink to the ink pressure chamber structure body 11 from an ink introducing path 41 of the holder 40. The ink discharge port 18 discharges the ink in the ink pressure chamber structure body 11 to an ink collection path 42 of the holder 40. The ink introducing path 41 is connected with an introducing pipe 51 for introducing ink from outside, and the ink collection path 42 is connected with a collection pipe 52 for collecting ink to the outside.

The head portion 10 supplies the ink flowing through the introducing pipe 51 and the ink introducing path 41 from the ink supply port 17 to the ink pressure chamber structure body 11 to fill the ink in the ink pressure chambers 14. The head portion 10 collects the ink in the ink pressure chamber structure body 11 flowing through the ink discharge port 18 and the ink collection path 42 in the collection pipe 52 to circulate the ink to be filled in the ink pressure chamber 14. In this way, the ink in the ink pressure chamber 14 is maintained at a constant temperature.

Electrodes 16 are arranged at the lateral sides of the piezoelectric member partition walls 13 inside the ink pressure chamber 14. When a voltage is applied to the electrodes 16, the piezoelectric member partition walls 13 are deformed and a pressure fluctuation occurs in each of the ink pressure chambers 14, and as a result, ink droplets are ejected from the two nozzles 21 of each ink pressure chamber 14. The mask plate 30 which is, for example, made of metal is boned to the frame 12 to mask around the nozzle plate 20.

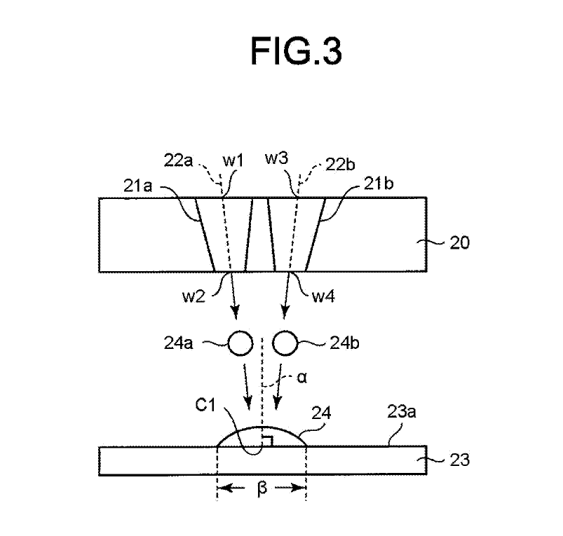

Two nozzles 21a, 21b piercing the nozzle plate 20 are formed in the same shape. As shown in FIG. 3, axes 22a, 22b of the two nozzles 21a, 21b are respectively directed to a direction of a center C1 of a dot area β serving as the ink impact area in an image receiving medium 23. The axis 22a of the nozzle 21a is a line connecting a center of gravity of area w1 at the inlet side of the nozzle 21a with a center of gravity of area w2 at the outlet side thereof. The axis 22b of the nozzle 21b is a line connecting a center of gravity of area w3 at the inlet side of the nozzle 21b with a center of gravity of area w4 at the outlet side thereof. The axes 22a, 22b are inclined against a α direction which is perpendicular to a surface 23a of the image receiving medium 23 in such a manner that the axes 22a, 22b are directed to the direction of the center C1 of the dot area β in the image receiving medium 23.

In the inkjet head 1 with such a constitution, when a voltage is applied to the electrodes 16, the piezoelectric member partition walls 13 are deformed, and thus pressure fluctuation occurs in the ink pressure chambers 14. Through the pressure fluctuation, an ink droplet 24a and an ink droplet 24b having almost same amount are respectively ejected from the nozzles 21a, 21b. The ink droplet 24a and the ink droplet 24b which are respectively ejected from the nozzles 21a, 21b are gathered towards the direction of the center C1 of the dot area β in the image receiving medium 23 due to the inclination of each of the axes 22a, 22b of the nozzles 21a, 21b. The ejected ink droplets 24a, 24b are coalesced at the time of impacting on the image receiving medium 23 to form an impact dot 24 in the dot area β. Because the ejected droplets 24a, 24b are coalesced in the image receiving medium 23 without dispersing, a desired high concentration printing or high-speed printing can be realized efficiently. The nozzles 21a, 21b of which the axes 22a, 22b are directed to the direction of the center C1 of the dot area β in the image receiving medium 23 prevent the dot area β in the image receiving medium 23 from expanding.

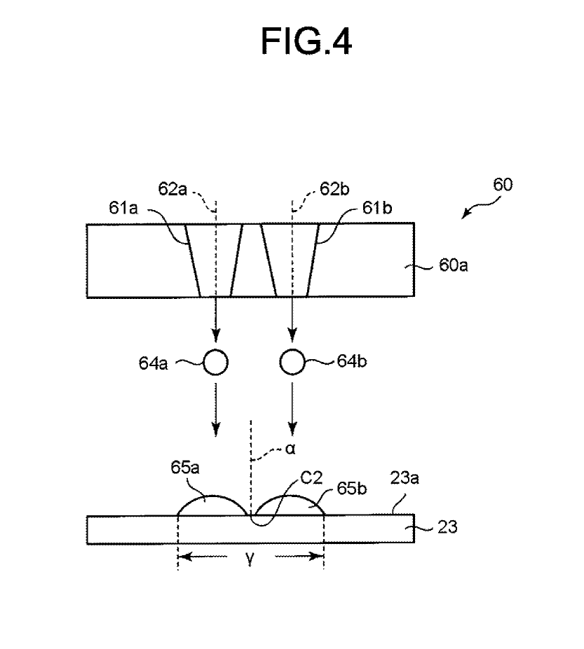

As a comparative example of the head portion 10 of the present embodiment, an ink impact area of a head portion of which two axes of nozzles aren't inclined is described. In a head portion 60 as shown in the comparative example in FIG. 4, each of axes 62a, 62b of two nozzles 61a, 61b, which are formed in a nozzle plate 60a for each ink pressure chamber, is parallel to the a direction perpendicular to the surface 23a of the image receiving medium 23.

An ink droplet 64a and an ink droplet 64b respectively ejected from the nozzles 61a, 61b of the head portion 60 in the comparative embodiment are dropped straight in the a direction perpendicular to the surface 23a of the image receiving medium 23. The ink droplet 64a and the ink droplet 64b that are dropped straight in the a direction perpendicular to the surface 23a of the image receiving medium 23 are impacted on the image receiving medium 23 respectively instead of coalesced, and form an impact dot 65a and an impact dot 65b. In the comparative embodiment, the ink droplet 64a and the ink droplet 64b respectively ejected from the nozzles 61a, 61b are dispersed into two impact dots 65a, 65b in the image receiving medium 23, and as a result, the dot area is also expanded to an area γ. In the comparative embodiment, the dot area is expanded since the impact dots 65a, 65b are dispersed, which hinders an efficient high concentration printing or high-speed printing.

In accordance with the present embodiment, each of axes 22a, 22b of the two nozzles 21a, 21b for each ink pressure chamber 14 are directed to the direction of the center C1 of the dot area β in the image receiving medium 23. The ink droplets 24a, 24b with desired amount respectively ejected from the nozzles 21a, 21b are directed to the direction of the center C1 of the dot area β in the image receiving medium 23 to gather and coalesce in the image receiving medium 23. Since the ink 24 with desired amount can be coalesced in the dot area β, it is possible to perform a high concentration printing or high-speed printing efficiently.

The present invention is not limited to the embodiment stated above, and various modifications are possible. No limitation is given to the number or the arrangement and the like of the liquid ejection section for each pressure generation chamber. A plurality of liquid ejection sections arranged for each pressure generation chamber may be arranged two-dimensionally.

For example, as shown in the modification in FIG. 5, three nozzles 71a, 71b, 71c piercing a nozzle plate 70 may be arranged for each ink pressure chamber to obtain a high concentration printing or high-speed printing. In the modification, each of axes 72a, 72b and 72c of three nozzles 71a, 71b, 71c are directed to a direction of a center C3 of an ink dot area δ in the image receiving medium 23. The axes 72a, 72c are inclined against the a direction which is perpendicular to the surface 23a of the image receiving medium 23 in such a manner that the axes 72a, 72c are directed to the direction of the center C3 of the dot area 6 in the image receiving medium 23. The axis 72b is parallel to the a direction. Ink droplets 74a, 74b and 74c to be respectively ejected from the nozzles 71a, 71b and 71c are directed to the direction of the center C3 of the dot area δ in the image receiving medium 23. The ejected ink droplets 74a, 74b and 74c are coalesced in the image receiving medium 23 to form an impact dot 74 in the dot area 5. Because the ejected ink droplets 74a, 74b and 74c are coalesced instead of dispersed in the image receiving medium 23, a desired high concentration printing or high-speed printing can be efficiently realized.

Further, as long as the directions of axes of a plurality of liquid ejection sections are directed to the center direction of the impact area, the inclination angle of the axes against the center direction is not limited; and the ink droplets (liquid) ejected respectively may not be coalesced in the impact area as long as they are capable of approaching each other. Further, the constitution of the driving section is also not limited, and for example, a piezoelectric element may be arranged as the driving section in the plate in which the liquid ejection sections are formed. Furthermore, the category of the liquid and the category of the image receiving medium and the like are not limited. The liquid is not limited to ink, and may be liquid including conductive particles for forming a wiring pattern and the like. The image receiving medium may be a normal paper, a plastic film, a ceramic and the like.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A liquid ejection head, comprising:
a pressure generation chamber in which liquid is filled;
a plate configured to connect with the pressure generation chamber and include a plurality of liquid ejection sections of which the axes are directed to the center direction of an impact area of the liquid; and
a driver configured to enable a pressure in the pressure generation chamber to fluctuate.

2. The liquid ejection head according to claim 1, wherein
the axis of each of the plurality of liquid ejection sections is directed to a center direction of an impact area of the liquid and intersects with each other.

3. The liquid ejection head according to claim 1, wherein
the axis of each of the plurality of liquid ejection sections is a line connecting a center of gravity of area at an inlet side of each of the plurality of liquid ejection sections with a center of gravity of area at a corresponding outlet side of each of the plurality of liquid ejection sections.

4. The liquid ejection head according to claim 2, wherein
the axis of each of the plurality of liquid ejection sections is a line connecting a center of gravity of area at an inlet side of each of the plurality of liquid ejection sections with a center of gravity of area at a corresponding outlet side of each of the plurality of liquid ejection sections.

5. The liquid ejection head according to claim 1, wherein
the axis of each of the plurality of liquid ejection sections is directed to a direction in which the liquid respectively to be ejected from the plurality of liquid ejection sections is impacted on the impact area while approaching each other.

6. The liquid ejection head according to claim 1, wherein
the axis of each of the plurality of liquid ejection sections is directed to a direction in which the liquid respectively to be ejected from the plurality of liquid ejection sections is coalesced and impacted on the impact area.
